(19) United States
(12) Patent Application Publication
(10) Pub. No.: US 2007/0295148 A1
(43) Pub. Date: Dec. 27, 2007

(54) Composite Lever and Method of Making Same

(76) Inventors: Gerald W. Seim, Hope, IN (US); Kenneth J. Seim, Hope, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/419,827

(22) Filed: May 23, 2006

(51) Int. Cl. G05G 1/04

(52) U.S. Cl. 74/519

(57) ABSTRACT

The present invention is a composite transmission selector lever that avoids the multiple manufacturing steps of current levers and in addition gives a significant reduction in cost. The lever comprises an open-sided, elongated stamped, sheet steel element having a triangular cross section shape with the open end of the triangle curved inwardly. The triangular shape is to provide the maximum bending strength to the resultant structure. One end of the mechanism is crimped and/or welded to fasten over the circular section of a base and the other end is formed to extend to an operator handle. A wire for a switch in the handle is laid through the open side of the element and the composite assembly is overmolded with a high strength thermoplastic material, such as polyamide 6, having a surface finish suitable for an as-molded condition. The molding material substantially encloses the interior of the open-sided element, thus securing the electrically conductive wire in place and providing a significant contribution to the overall bending strength of the assembly.

### BACKGROUND OF THE INVENTION

The present invention relates to levers and more specifically to improvements in how such levers are made.

Over the centuries, levers have been an essential part of any activity in which mechanical devices are controlled, actuated, manipulated, and the like. Usually, a lever consists of a base connecting to some part of the machinery, such as a linkage, a shaft which is either straight or bent according to the application and an operator handle to enable ergonometric and efficient grasping of the lever to induce the proper movement. The lever can be movement through an arc in a single plane or multiple planes, as in a gear shift. In some cases, the lever could even be rotated about its axis for further mechanical output. In recent years, there are many instances in which a lever providing a mechanical output must also provide an electrical output, usually by some form of switch. Levers of this type are most commonly found in the automotive field, although the present invention has an application not so limited by the automotive environment.

For example, in the field of automatic transmission equipped vehicles designed to tow a boat or trailer, it is necessary to disable an automatic overdrive feature when towing. The transmission shift lever includes a base and an operator handle on which an electrical switch is attached to de-activate the overdrive control in the transmission control system. Thus, operation of the lever consists of physically moving the lever to engage gears/clutches and then electrically activate a solenoid or other device to activate or de-activate the overdrive control. Existing transmission selector levers are expensive machined assemblies requiring a solid shaft to provide the appropriate bending strength and a drilled hole extending through a substantial portion of the shaft. The through hole receives an electrical conductor that extends from a connector at the base of the lever to a switch assembly in the operator handle. This assembly requires machining and multi-steps to achieve a final product. Replacing the shaft with a thick-walled tubing to achieve the deflection strength reduces cost but is still costly because thick-walled tubing is expensive to make. The use of these shafts is more problematic when the shaft must be bent, frequently in multiple places, to accommodate functional and operator ergonomic requirements. After the bending is completed, the wire must be threaded through the shaft. Because the hole is drilled, a subsequent and further step in fastening the switch terminal and/or connector must take place. Finally, the shaft must be painted to match the handle color.

Another alternative to forming the lever is to cast it from some form of plastic. Although this may simplify the manufacturing process when dealing with complex multiple bends and complex shapes, it does not have the requisite strength necessary to provide force input for devices like those used in transmissions.

Thus, a need exists in the art for a lever that has the capability of being economically formed but at the same time meeting structural integrity requirements.

### BRIEF SUMMARY OF THE INVENTION

In one form, the invention comprises an elongated structure having longitudinal edges. The elongated structure is formed along its longitudinal axis so that the longitudinal edges are at least adjacent each other to form interior walls for a structure. The structure has a cross sectional configuration such that the interior walls are spaced from each other to form an interior therebetween. Structural material is molded to at least substantially fill the interior between the interior walls, whereby the elongated structure and the molded structural material combine to reinforce one another.

In yet another form, the invention comprises a method for forming a lever comprising the steps of forming an elongated structure having longitudinal edges, along its longitudinal axis, so that the longitudinal edges are at last adjacent one another to form interior walls of the structure. The structure is formed to define a cross sectional configuration such that the interior walls are spaced to form an interior therebetween. A structural material is molded to at least substantially fill the interior of the elongated structure whereby the elongated structure and molded material combine to reinforce one another.

One object of the present invention is to provide a lever that is significantly less costly to manufacture, but which has the required strength for mechanical outputs.

Related objects and advantages of the present invention will be apparent from the following description.

### BRIEF DESCRIPTION OF THE SEVERAL VIEWS OF THE DRAWINGS

FIG. 1 is a top view of a lever embodying the present invention.

FIG. 2 is a longitudinal section view of the lever of FIG. 1 taken on lines 2-2 of FIG. 1.

FIG. 3 is a cross sectional view of the lever shown in FIGS. 1 and 2 taken on lines 3-3 of FIG. 2.

FIG. 4 is a cross sectional view of the lever shown in FIGS. 1 and 2 taken on lines 4-4 of FIG. 2.

FIG. 5 is a side view of the lever of FIGS. 1 and 2 taken on lines 5-5 of FIG. 1.

FIG. 6 is a perspective view of one of the components of the lever of FIG. 1 in an intermediate assembly position.

FIG. 7 is a perspective view of the component of FIG. 6 but in a later assembly position.

FIG. 8 is a fragmentary side view of an alternative form of one of the components of the lever of FIG. 1.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

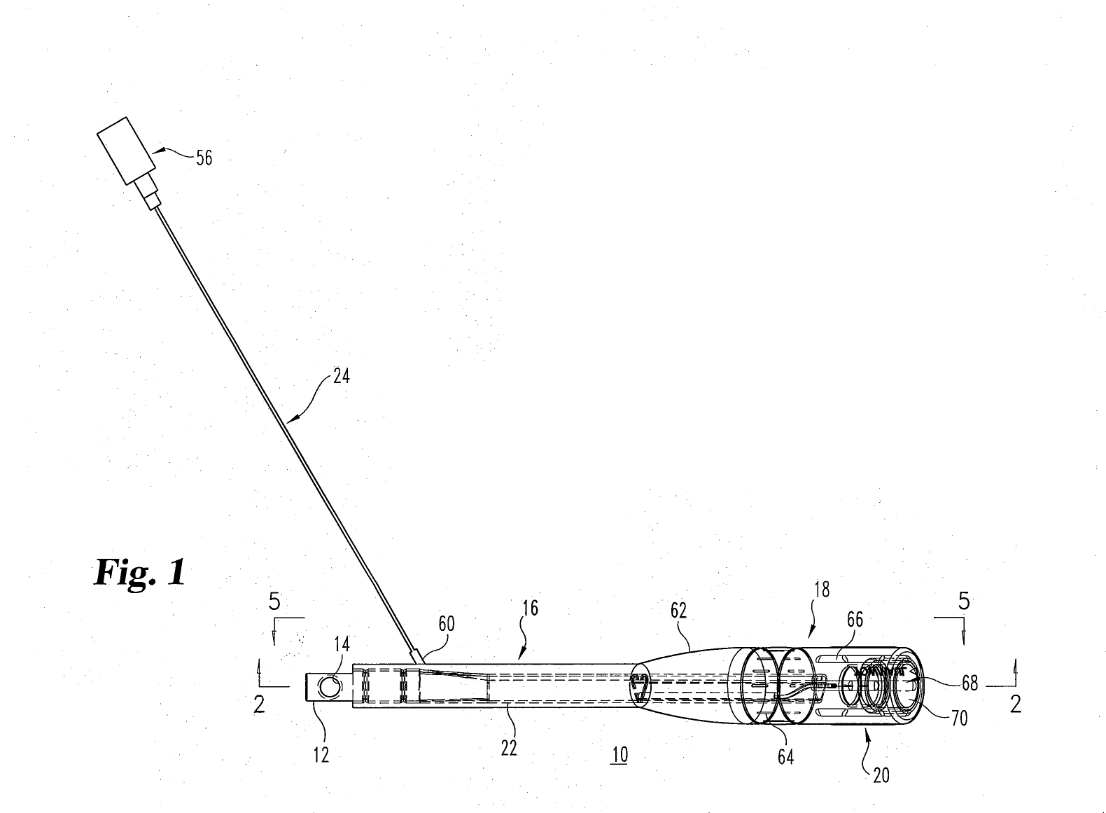

FIG. 1 shows a lever generally indicated by reference character 10. Lever 10, by way of example, is used as a transmission selector lever. However, it could be employed for any one of a multitude of functions providing a mechanical output. Lever 10 comprises a base 12 shown herein as cylindrical and having a through hole 14 for appropriate connection to a transmission selector mechanism. Lever 10 has a shaft section generally indicated by reference character 16 and an operator handle 18 containing a switch assembly 20. As described below, the lever has the function of movement to place a transmission into gear and, at the same time, the switch assembly 20 is engaged when certain conditions are experienced, such as towing. The shaft assembly 16 comprises an elongated structural element 22 extending from base 12 to handle assembly 18. Elongated structural element 22, as illustrated, is formed by stamping sheet metal of appropriate thickness and strength into a shape that will be described in detail later. The elongated element 22 receives a wire generally indicated by reference character 24 which extends from a location adjacent base 12 to the switch assembly 20. As described below, the shaft assembly 16 and handle assembly 18 both comprise a structural material 62 that is molded over and around the structural element 22 to achieve significant reductions in manufacturing cost. The resulting lever fully meets the strength requirements that were heretofore met by solid steel shafts, drilled to receive a wire before assembly, and thick wall tubing shafts.

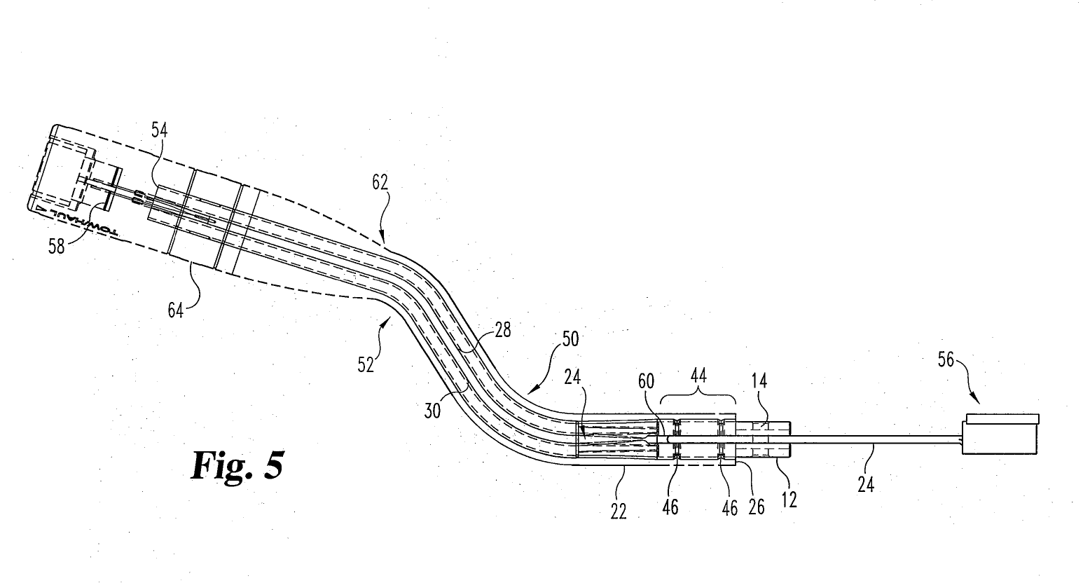

Referring to FIG. 5, the base 12 is generally cylindrical and receives the base end 26 of the structural element 22. As stated previously, the structural element 22 is formed from sheet metal of appropriate thickness and strength to achieve the structural requirements of the application. One example of material that may be used for this is 0.060 inch 1018 to 1020 cold rolled steel (CRS). However, it should be apparent to those skilled in the art that many other forms of sheet material may be employed for this purpose. The structural assembly 22 starts out generally as a flat, elongated sheet element. Through a series of hits in a progressive die, it is formed into the shape shown in FIG. 5. That shape involves longitudinal edges 28 and 30 positioned closely adjacent one another as shown in FIG. 5. As shown in FIG. 4, longitudinal edges 28 and 30 are formed by curving structural element 22 over along a longitudinal side 32 to form, in a general sense, a triangular shape. The longitudinal edges 28 and 30 are curved in towards longitudinal line 32 at sections 34 and 36. As is apparent from FIG. 4, this manner of folding the structural element 22 causes interior walls 38 and 40 to be spaced from one another, thereby forming an interior 42 for the structural element 22. The longitudinal edges 28 and 30 are spaced from one another in FIG. 4 to permit sideways insertion of the wire 24 into the interior 42 of the structural element 22 and sometimes adjacent to line 32. Although the longitudinal edges 28 and 30 are spaced from one another, it should be apparent to those skilled in the art that if the lever is to be used without a wire assembly through the interior, the edges may be closer to one another and may even touch and/or interlock, as described below.

As illustrated in FIG. 4, the cross section configuration of structural element 22 is generally triangular in shape and, with the curved section adjacent the longitudinal edges 28 and 30, is generally heart-shaped. This is done to contribute maximum strength to the ultimate structure. It is, however, one of the many forms that may be employed for the longitudinal structural element 22. The primary purpose of element 22 is to be bent over on itself to form a shape that has an interior and which is capable of being overmolded, as discussed below in detail.

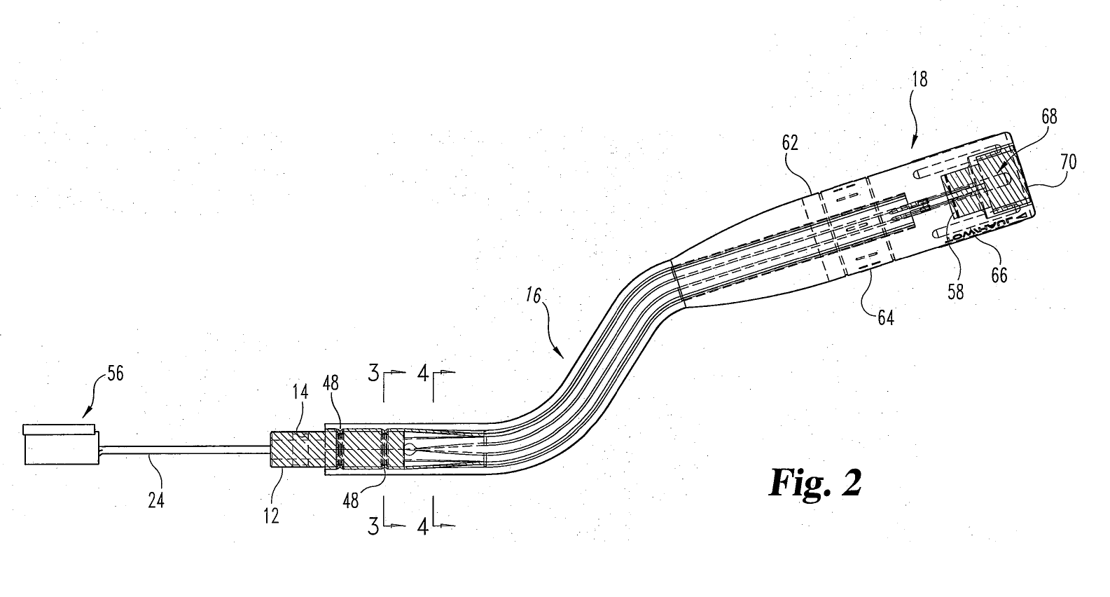

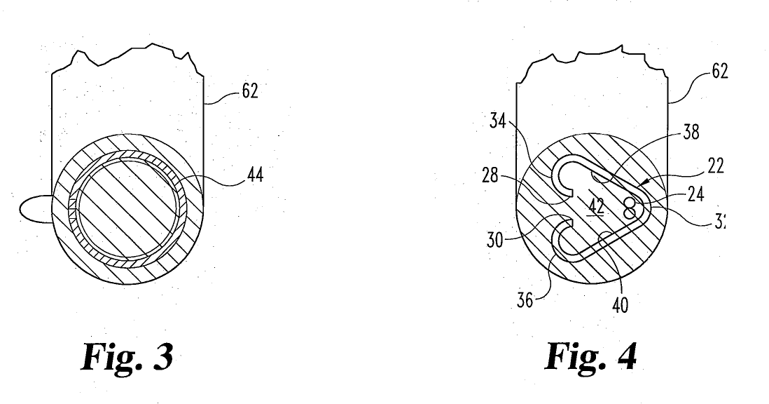

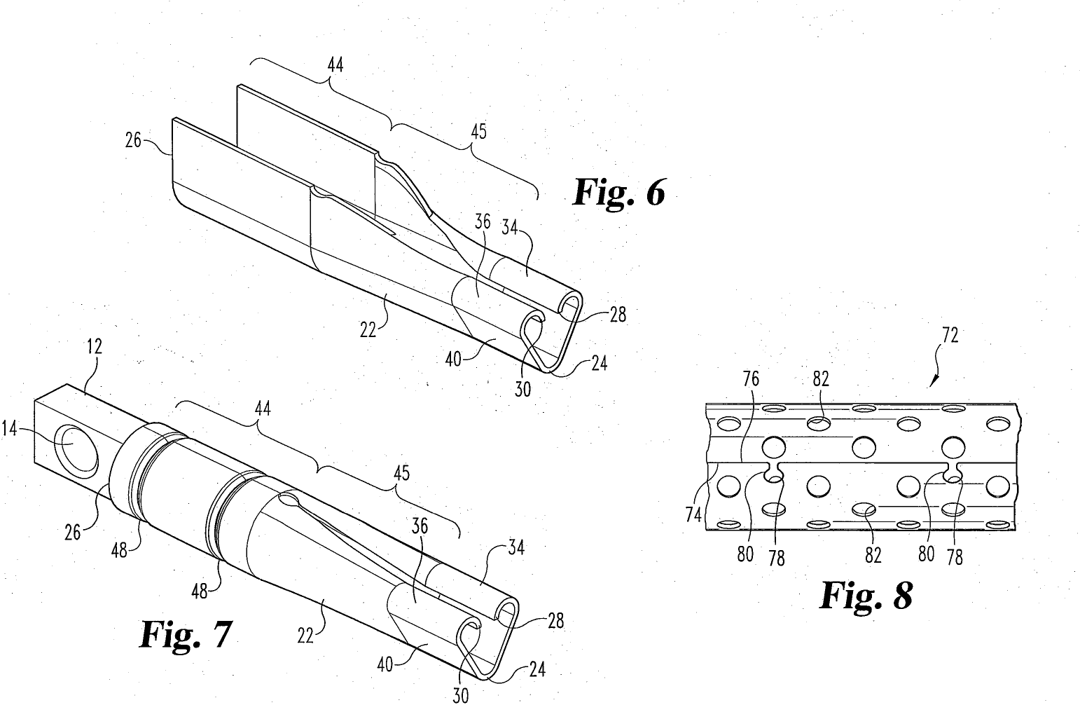

Referring now to FIGS. 5, 6, and 7 and FIG. 3, the structural element 22 makes a transition 45 from the generally triangular shape shown in FIG. 4 to a cylindrical shaped section 44 shown in FIG. 5 and in FIG. 3. This transition 45 to the cylindrical shape is so that the exterior of structural element 22 at its base end 26 conforms to the outer shape of base element 12. As illustrated, base shape 12 is cylindrical and therefore the end of structural element 22 is cylindrically shaped to conform to its surface. It should be apparent, however, that base element 12 may be provided in any one of a number of configurations and that structural element end section 44 may be formed to conform to those configurations. Base element 12 has a pair of circumferential grooves 46 so that structural element 22 may be crimped at 48 (shown in FIG. 2) to connect the structural element 22 to base 12. Although crimping is illustrated, the fastening may take place using a variety of techniques, including welding and adhesives, etc.

As shown in FIG. 5, structural element 22 has a first bend at 50 and a second bend at 52. This is done for operator ergonomics to place the lever in such a position that it permits convenient manipulation. It should be apparent to those skilled in the art that the element 22 may be formed as a straight section, with one bend, or with more than two bends, as the application requires. The current capability of stamping techniques easily allows the formation of a structural element with the cross sectional configurations shown in FIGS. 3 and 4 and maintaining uniform structural and minimum bowing of the material. The structural element has the cross section of FIG. 4 from beyond the cylindrical section to an upper end 54.

The structural element 22 shown in FIGS. 5, 6, and 7 has an approximate triangular cross sectional shape and has longitudinal edges that leave a gap for the sideways insertion of the wire 24. The longitudinal edges of the elongated structural element can be formed to be closer than that and even abut one another, as shown in FIG. 8. FIG. 8 shows an alternative longitudinal structural element 72 having longitudinal edges 74 and 76 which abut one another after the forming process is complete. Longitudinal edges 76 and 74 may be locked together by a series of notches 78 in longitudinal edge 74 and interfitting tabs 80 in longitudinal edge 76. The elements are then locked together similar to that found in a crossword puzzle. Since the edges 74 and 76 abut one another, it is necessary to lay the wire 24 into the interior of the structural element 72 prior to the final forming process of joining the longitudinal edges together. The completed structure is then overmolded with structural material, as in the embodiment shown in FIGS. 1-7. It should be noted that a plurality of holes 82 are formed in structural element 72 to obtain more uniform distribution of the molding material.

As shown in FIG. 5, the wire 24 is laid into the gap between the longitudinal edges 28 and 30. This allows for several advantages. The first is the ease with which the wire can be laid into the interior of the structural element 22 and the second is that the wire may have a preassembled connector 56 of significant proportions that would not permit threading through passages as drilled in the prior art and a preassembled switch terminal 58 positioned adjacent the upper end 54 of the structural element 22. To enable the molding process set out below, a tubular element 60 is provided over the wire 24 adjacent one end of base element 12 to provide definition for the mold as the wire exits the space between the longitudinal edges 28 and 30 adjacent base element 12.

The assembly of the wire 24 and the structural element 22 and other parts is placed into a mold and then a structural material is molded such that it at least fills the interior 42 of the structural element 22 and preferably overmolds the exterior of structural element 22 to provide a uniform external cross section. As shown in FIG. 3, that cross section is circular. However, it should be noted that many different forms of exterior shapes can be formed. The outlines of the structural molded material 62 are shown in phantom in FIG. 5 and designated by reference character 62. The molded structural material 62 forms an integral outer structure for the section 16 and also for the handle 18. Structural material 62 may be any form of moldable material that fills the interior 42 of structural element 22 to form a resultant structure that has superior structural integrity compared to a structural element 22 and structural molded material 62 separately. One example of such a material for the molded structural material 62 can be a thermoplastic of 40% glass and mineral filled nylon or polyamide 6. It should be apparent to those skilled in the art that thermoplastic materials suitable for applications in this environment are constantly changing and that the structural material 62 may be formed from then-current materials that are available. The polyamide 6 has relatively low mold shrinkage and good fatigue resistance. It has a melting temperature range of approximately 230-280 degrees C. Because of the elevated temperature range for the molded material 62, the wire 24 requires an electrical insulation material that has a melting point higher than that for the molded material 62. A suitable material for insulating wire 24 is Teflon, although other high temperature materials may be employed.

Once the material 62 is molded, the structure shown in FIGS. 1 and 2 is the result. It can be seen that the normal features of the operator handle 18 making it suitable for operator manipulation are formed. These include axially extending ribs 64 positioned around the circumference and a plurality of axially extending recesses 66 positioned around the circumference of the handle. The switch terminal 58 receives a switch 68 that has an operator manipulated button 70 biased to an open position and can be depressed to establish electrical contact between the wires 24 and thus provide control input to the transmission.

The resultant lever offers significant manufacturing economies because the process of providing a passage through the handle portion 16 from the operator handle 18 is already provided in the forming of the structural element 22. Connecting the structural element 22 to the base 12 is a process that is easily automated and capable of a variety of fastening approaches to form an effective interconnection. The molding process by which the structural molded material 62 is molded in the interior of the structural element as well as over the exterior is also easily automated and, in one process, establishes a final product with a finish that meets customer requirements in its as-molded state. The only remaining step in the process is to insert the switch assembly 68 into the operator handle. The resultant structure easily meets the strength requirements for such a lever in terms of bending, appearance, and other form and fit functions.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A lever comprising:
an elongated structure having longitudinal edges, said structure formed along its longitudinal axis so that said longitudinal edges are at least adjacent each other to form interior walls to said structure, said structure having a cross sectional configuration such that the interior walls are spaced from each other to form an interior therebetween; and
structural material molded to at least substantially fill the interior between said interior walls whereby the elongated structure and said molded structural material combine to reinforce one another.

2. A lever, as claimed in claim 1, further comprising an electrically conductive wire positioned longitudinally through the interior of said structure, said electrically conductive wire being overmolded by said molded structural material to support it within said interior.

3. A lever, as claimed in claim 2, wherein said molded structural material is thermoplastic and said electrically conductive wire is insulated with material having a higher melting point than the melting point for said molded structural material.

4. A lever, as claimed in claim 1, wherein said elongated structure has at least one bend intermediate the ends thereof.

5. A lever, as claimed in claim 4, wherein said elongated structure has two bends intermediate the ends thereof.

6. A lever, as claimed in claim 1, further comprising an element positioned at one end thereof, said elongated structure being fastened at one end to connect to said element.

7. A lever, as claimed in claim 1, wherein said elongated structure is fastened to said element by crimping.

8. A lever, as claimed in claim 7, wherein said element is cylindrical and said elongated structure is crimped to conform to said cylindrical element.

9. A lever, as claimed in claim 6, wherein said element provides a mechanical connection for said lever and said lever further comprises an operator handle at the end opposite from said element, said handle being integral with said molded structural material.

10. A lever, as claimed in claim 9, further comprising an electrical switch positioned in said handle and an electrical wire extending along the interior of said elongated structure and to the exterior thereof between adjacent longitudinal edges.

11. A lever, as claimed in claim 10, wherein said molded structural material is thermoplastic and said wire is insulated with material having a higher melting point than said molded structural material.

12. A lever, as claimed in claim 10, wherein said lever further comprises a switch terminal assembly molded into said handle, said handle having a recess receiving said switch, said switch terminal assembly having electrically conductive wire leads extending into said recess and said wire extending along the interior of said elongated structure and through adjacent longitudinal edges to the exterior thereof.

13. A lever, as claimed in claim 12, wherein said molded structural material is Polyamide 6 and said wire insulation is Teflon.

14. A lever, as claimed in claim 1, wherein the cross section of said elongated structure is non-circular and said molded structural material extends through the interior of said elongated structure and also on the exterior to define a given exterior cross section configuration.

15. A lever, as claimed in claim 14, wherein said given exterior cross section is circular.

16. A lever, as claimed in claim 14, wherein the cross section of said elongated structure is generally triangular.

17. A lever, as claimed in claim 16, wherein the cross section of said elongated structure has longitudinal edges turned inwardly towards the interior thereof.

18. A lever, as claimed in claim 1, wherein said elongated structure is sheet metal formed by stamping.

19. A lever, as claimed in claim 1, wherein said longitudinal edges of said elongated structure abut one another and said edges have means with which to interlock the longitudinal edges.

20. A method for forming a lever, said method comprising the steps of:
forming an elongated structure having longitudinal edges along its longitudinal axis so that said longitudinal edges are at least adjacent each other to form interior walls of said structure, the structure being formed to define a cross sectional configuration such that the interior walls are spaced to form an interior therebetween; and
molding structural material to at least substantially fill the interior whereby the elongated structure and said molded structural material combine to reinforce one another.

21. A method, as claimed in claim 20, further comprising the steps of:
laying a wire into the interior of said elongated structure through the space between said longitudinal edges of said elongated structure before the interior of said structure is filled with molded structural material.

22. A method, as claimed in claim 21, wherein said lever is connected to an element providing a mechanical connection and wherein said elongated structure is fastened onto said element before said structural material is molded into the interior of said elongated structure.

23. A method, as claimed in claim 22, wherein said lever has an operator handle and wherein said method further comprises the steps of:
laying said wire through said interior of said elongated structure; and
molding a handle integrally with the molding of structural material within the interior of said elongated structure.

24. A method, as claimed in claim 20, wherein said elongated structure is sheet metal formed by stamping.
